(19) United States
(12) Patent Application Publication
(10) Pub. No.: US 2012/0072257 A1
(43) Pub. Date: Mar. 22, 2012

(54) Optimizing Facility Utilization For Service Delivery

(75) Inventors: Jayanta Basak, New Delhi (IN); Kashyap Dixit, State College, PA (US); Pranav Gupta, Noida (IN); Julio Heshiki, Bangalore (IN); Gyana R. Parija, New Delhi (IN)

(73) Assignee: INTERNATIONAL BUSINESS MACHINES CORPORATION, Armonk, NY (US)

(21) Appl. No.: 12/884,136

(22) Filed: Sep. 16, 2010

(51) Int. Cl. G06Q 10/00

(52) U.S. Cl. 705/7.25; 705/7.11

(57) ABSTRACT

A processor identifies a first demand type, which includes a first set of demand requirements, and also identifies a second demand type, which includes a second set of demand requirements. Next, the processor retrieves a demand compatibility rule, which specifies a compatibility between the first set of demand requirements and the second set of demand requirements. The processor uses the demand compatibility rule to compute a demand type overlap value between the first demand type and the second demand type. In turn, the processor computes a minimum facility requirement based upon the demand type overlap value and generates a facility report that includes the minimum facility requirement.

### TECHNICAL FIELD

The present disclosure relates to optimizing facility utilization for service delivery. More particularly, the present disclosure relates to optimizing facility utilization based upon demand requirement relationships between different demand types.

### BACKGROUND

Businesses spend a large amount of money on facility expenses. Many businesses manage facilities in multiple locations that are located in multiple geographical locations. Some businesses are “open” 24 hours a day in order to handle demands received from different geographical locations during different times of the day. As businesses grow, managing facility areas is an important aspect of managing the businesses' expenses. In some situations, a business may utilize multiple facility areas that have different capabilities. For example, an office building may have high-speed network capability on one floor, and may have additional telephone capability on a different floor.

### SUMMARY

A processor identifies a first demand type, which includes a first set of demand requirements, and also identifies a second demand type, which includes a second set of demand requirements. Next, the processor retrieves a demand compatibility rule, which specifies a compatibility between the first set of demand requirements and the second set of demand requirements. The processor uses the demand compatibility rule to compute a demand type overlap value between the first demand type and the second demand type. In turn, the processor computes a minimum facility requirement based upon the demand type overlap value and generates a facility report that includes the minimum facility requirement.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE DRAWINGS

The present disclosure may be better understood, and its numerous objects, features, and advantages made apparent to those skilled in the art by referencing the accompanying drawings, wherein:

FIG. 1 is a diagram showing a system architecture that optimizes facility utilization based upon compatibility relationships between demand requirements;

FIG. 2 is a flowchart showing steps taken in computing facility utilization using an enumeration approach;

FIG. 3A is a diagram showing an example of a demand type table;

FIG. 3B is a diagram showing an example of a demand compatibility rules table;

FIG. 4A is a diagram showing an example of a demand type overlap table;

FIG. 4B is a diagram showing an example of a demand type relationship graph;

FIG. 5 is a flowchart showing steps taken in an optimization approach to maximizing facility usage;

FIG. 6 is a diagram showing an example of a supply table that includes supply types and corresponding supply parameters;

FIG. 7A is a diagram showing an example of a demand type table;

FIG. 7B is a diagram showing an example of a mapping matrix;

FIG. 8 is a block diagram example of a data processing system in which the methods described herein can be implemented; and

FIG. 9 provides an extension example of the information handling system environment shown in FIG. 8 to illustrate that the methods described herein can be performed on a wide variety of information handling systems which operate in a networked environment.

### DETAILED DESCRIPTION

Certain specific details are set forth in the following description and figures to provide a thorough understanding of various embodiments of the disclosure. Certain well-known details often associated with computing and software technology are not set forth in the following disclosure, however, to avoid unnecessarily obscuring the various embodiments of the disclosure. Further, those of ordinary skill in the relevant art will understand that they can practice other embodiments of the disclosure without one or more of the details described below. Finally, while various methods are described with reference to steps and sequences in the following disclosure, the description as such is for providing a clear implementation of embodiments of the disclosure, and the steps and sequences of steps should not be taken as required to practice this disclosure. Instead, the following is intended to provide a detailed description of an example of the disclosure and should not be taken to be limiting of the disclosure itself. Rather, any number of variations may fall within the scope of the disclosure, which is defined by the claims that follow the description.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The following detailed description will generally follow the summary of the disclosure, as set forth above, further explaining and expanding the definitions of the various aspects and embodiments of the disclosure as necessary.

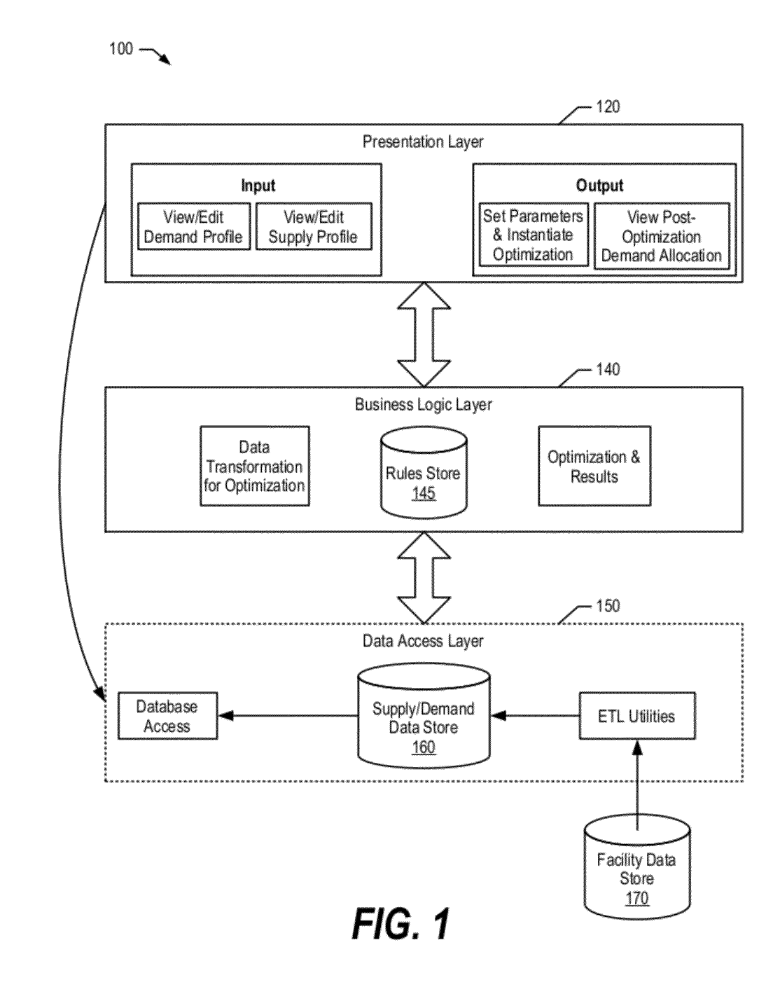

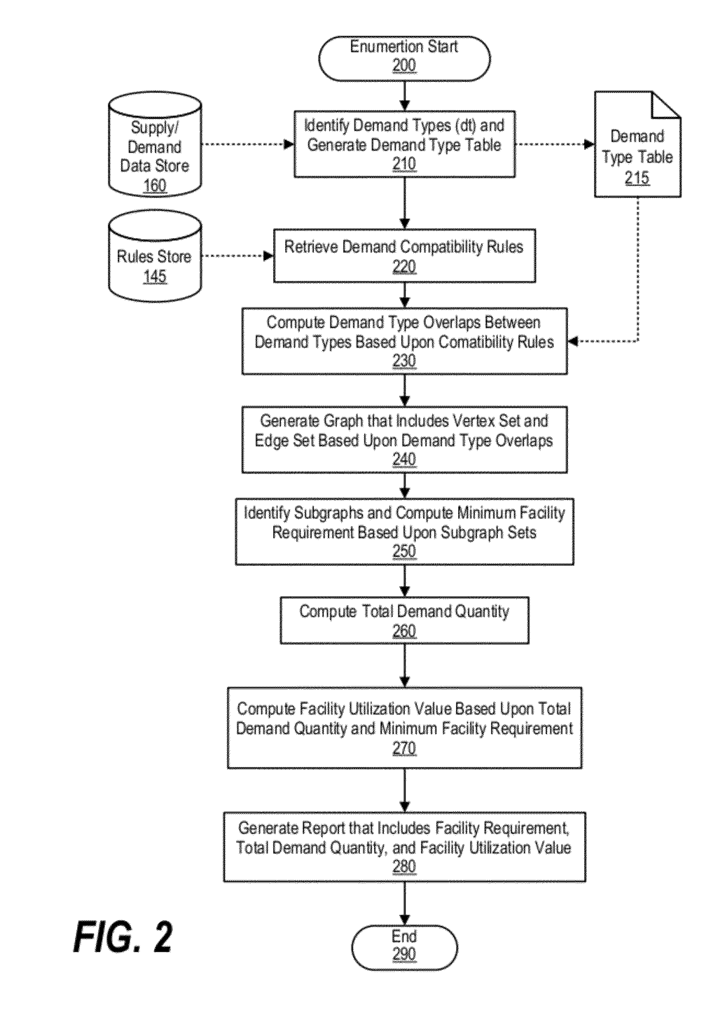

FIG. 1 is a diagram showing a system architecture that optimizes facility utilization based upon compatibility relationships between demand requirements. System architecture 100 analytically optimizes facility utilization using two approaches, which are an enumeration approach and an optimization approach. System architecture 100 uses the enumeration approach facility areas are similar, and uses the optimization approach when facility areas are different. In addition, system architecture 100 minimizes demand fragmentation between different clusters of facility areas (see FIGS. 2-7 and corresponding text for further details).

System architecture 100 includes presentation layer 120, which couples to business logic layer 140 and data access layer 150. Presentation layer 120 provides a capability to view and edit supply/demand profiles for configuring a particular facility utilization optimization, and also includes an output capability that provides optimization results.

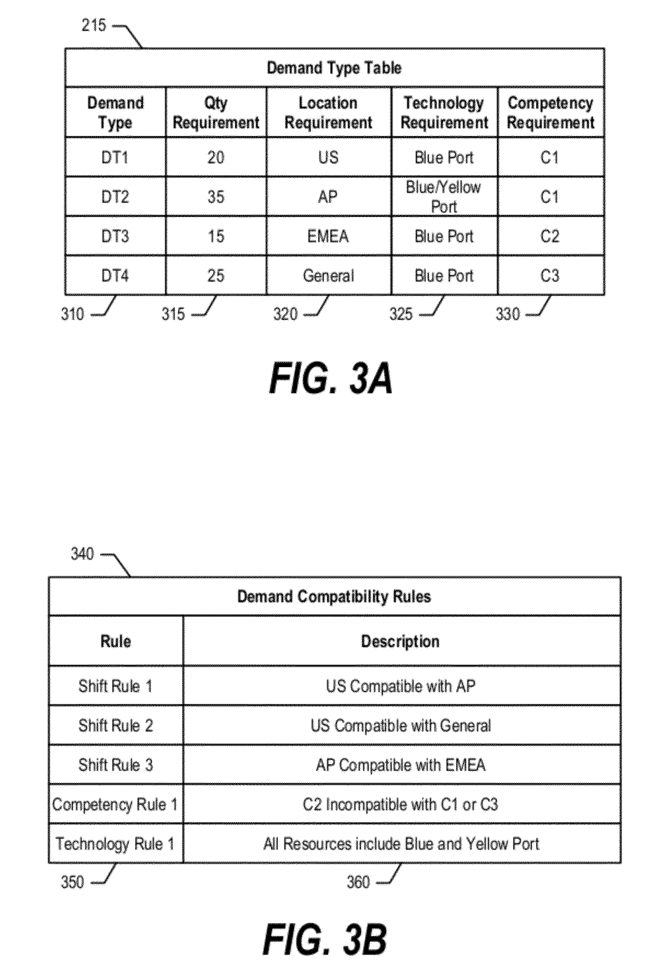

Business logic layer 140 includes rules store 145, which stores compatibility rules that business logic layer 140 utilizes during data transformation and optimization (see FIGS. 2, 3B and corresponding text for further details). Data access layer 150 constructs a consolidated view of facility information (supply availability and demand requirements) and stores the facility information in supply/demand data store 160. In one embodiment, data access layer 150 extracts facility information from facility data store 170 and populates data in supply/demand data store 160, such as with data access layer 160's ETL (Extract, Transform, and Load Data) Utilities.

FIG. 2 is a flowchart showing steps taken in computing facility utilization using an enumeration approach. Processing commences at 200, whereupon processing identifies different demand types (dt) included in supply/demand data store 160 and generates demand type table 215 (step 210). Referring to FIG. 3A, table 215 shows four different demand types (dt1-dt4) in table 215. As FIG. 3A shows, a demand type includes a set of demand type requirements, such as a quantity requirement, a location requirement, a technology requirement, and a competency requirement (e.g., technical specialty, a company, etc.).

At step 220, processing retrieves demand compatibility rules from rules store 145. The demand compatibility rules specify compatibilities and/or incompatibilities between the different demand types. For example, two different demand types with different location requirements may be able to share a particular facility area (compatible), whereas two different demand types with different competencies may not be able to share the same facility area (incompatible) (see FIG. 3B and corresponding text for further details).

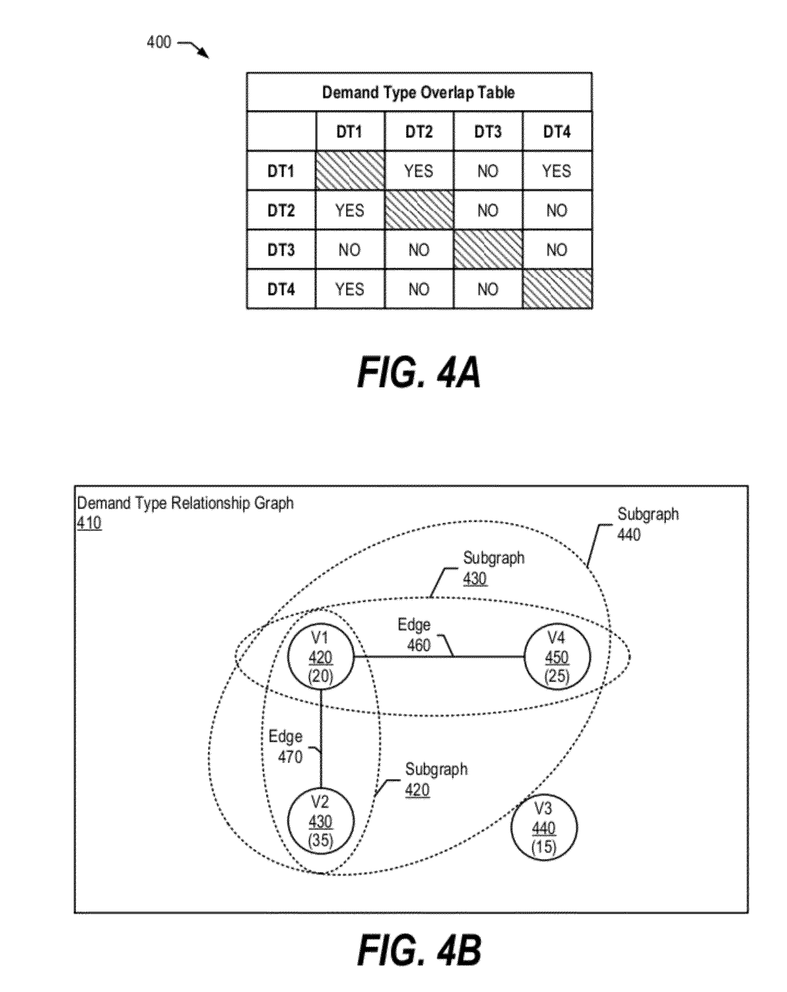

Next, processing computes demand type overlaps between the different demand types based upon the retrieved demand compatibility rules (step 230). In one embodiment, processing generates a demand type overlap table that identifies overlaps between the different demand types (see FIG. 4A and corresponding text for further details). At step 240, processing generates a demand type relationship graph based upon the computed demand type overlaps. The graph includes a vertex associated with each particular demand type quantity requirement and an edge for each computed demand type overlap. Referring to FIGS. 3A and 3B, vertexes are:
Quantity Requirement for dt1: Q(dt1)=20 (vertex 420)
Quantity Requirement for dt2: Q(dt2)=35 (vertex 430)
Quantity Requirement for dt3: Q(dt3)=15 (vertex 440)
Quantity Requirement for dt4: Q(dt4)=25 (vertex 450)

Regarding edges, since demand type overlap exists between dt1 and dt2, demand type relationship graph 410 includes edge 470, which corresponds to the demand type overlap value between dt1 and dt2 (Cardinality(Q(dt1)∩Q(dt2))=min{Q(dt1),Q(dt2)}. Likewise, since demand type overlap exists between dt1 and dt4, demand type relationship graph 410 includes edge 460, which corresponds to the demand type overlap value between dt1 and dt4 (Cardinality(Q(dt1)∩Q(dt4))=min{Q(dt1),Q(dt4)}.

At step 250, processing identifies subgraphs included in the generated graphs, and computes a minimum facility requirement based upon the identified subgraphs. Referring to FIG. 4B:

$$\begin{matrix}C ( Dt 1 ⋂ Dt 2 ) = min \{ 20 , 35 \} \\ = 20 ( subgraph 480 ) ;\end{matrix}$$

$$\begin{matrix}C ( Dt 1 ⋂ Dt 4 ) = min \{ 20 , 25 \} \\ = 20 ( subgraph 485 ) ;\end{matrix}$$

$$\begin{matrix}C ( Dt 1 ⋂ Dt 2 ⋂ Dt 4 ) = min \{ 20 , 35 , 25 \} \\ = 20 ( subgraph 490 ) ;\end{matrix}$$

$$\begin{matrix}Minimum Facility Requirement = Q ( dt 1 ) + Q ( dt 2 ) + \\ Q ( dt 3 ) + Q ( dt 4 ) - \\ C ( dt 1 ⋂ dt 2 ) - \\ C ( dt 1 ⋂ dt 4 ) + \\ C ( dt 1 ⋂ dt 2 ⋂ dt 4 ) \\ = 20 + 35 + 15 + 25 - \\ 20 - 20 + 20 \\ = 75\end{matrix}$$

As can be seen, processing computes the minimum facility requirement based upon each demand type quantity requirement less the amount of identified overlap. In addition, in situations when a demand type (dt1) shares between two different demand types (dt2 and dt4) that can not share amongst themselves, facility areas are added to the total demand quantity (C(dt1∩dt2∩dt4)). For example, if dt1 shares 20 facility areas with dt2, then dt1 may not be able to share the same facility areas with dt4 since dt4 cannot share facility areas with dt2:

Next, processing computes a total demand quantity (step 260) based upon demand type quantity requirements, and then computes a facility utilization based upon the computed total demand quantity and overall facility requirement (step 270). Continuing with the above example:

$$\begin{matrix}Total Demand Quantity = Q ( dt 1 ) + Q ( dt 2 ) + Q ( dt 3 ) + Q ( dt 4 ) \\ = 20 + 35 + 15 + 25 \\ = 95\end{matrix}$$

$$\begin{matrix}Facility Utilization = Facility Requirement / \\ Total Demand Quantity \\ = 95 / 75 \\ = 1.26\end{matrix}$$

Processing, at step 280, generates a report that includes the facility requirement, total demand quantity, and facility utilization at step 280, which a facility planner utilizes to analytically plan facility requirements. Enumeration approach processing ends at 290.

FIG. 3A is a diagram showing a demand type table. Table 215 includes four different demand types (dt1-dt4). Column 310 includes a list of demand type identifiers dt1-dt4, while columns 315-330 include a set of demand requirements for each of the demand types.

Column 315 includes a list of quantity requirements (e.g., number of required facility areas) for each of the different demand types. Column 320 includes a list of geographical location requirements, which identifies particular areas for required facility areas. Column 325 includes a list of technology requirements for each of the demand types (e.g., Ethernet port, PSTN port, etc.). Column 330 includes a list of competency requirements for each of the demand types. In one embodiment, the competency requirements correspond to a particular company or corporation. In this embodiment, demand compatibility rules may exist that prohibits one company to share facility areas with a competing company (see FIG. 3B and corresponding text for further details).

FIG. 3B is a diagram showing a demand compatibility rules table. Table 340 includes a list of rules that identify compatibilities and incompatibilities between demand types shown in FIG. 3A. Column 350 includes a list of demand compatibility rule identifiers and column 360 includes a list of corresponding rule descriptions. As can be seen, shift rule 1, shift rule 2, shift rule 3, and technology rule 1 specify compatibilities (e.g., what may be shared between demand types), and competency rule 1 specifies incompatibilities (e.g., what may not be shared between demand types). Based on theses compatibility rules, processing, in one embodiment, generates a demand type overlap table that identifies compatibilities between the different demand types (see FIG. 4A and corresponding text for further details).

FIG. 4A is a diagram showing a demand type overlap table that shows compatibilities between demand types dt1-dt4. Table 400 shows that, based upon demand compatibility rules shown in FIG. 3B, two demand type compatibilities exist, which are dt1 with dt2 and dt1 with dt4. Meaning, dt1 and dt2 may share facility areas, and dt1 and dt4 may share facility areas.

FIG. 4B is a diagram of a demand type relationship graph that includes three subgraphs. Demand type relationship graph 410 includes four vertexes, each corresponding to a particular demand type shown in FIG. 3A. V1 420 corresponds to demand type dt1 (quantity requirement 20); V2 430 corresponds to demand type dt2 (quantity requirement 35); V3 440 corresponds to demand type dt3 (quantity requirement 15); and V4 450 corresponds to demand type dt4 (quantity requirement 25).

Demand type relationship graph 410 also includes edges between some of the vertexes, signifying compatibilities between the corresponding demand types. Edge 460 signifies compatibility between demand types 1 and 4, and edge 470 signifies compatibility between demand types 1 and 2. The edges also correspond to the cardinality between the compatible demand types. For example, edge 460 corresponds to a demand type overlap value of 20 because demand type 1 can share up to 20 facility areas with demand type 4. Since demand type 3 is not compatible with dt1, dt2, or dt4, v3 440 does not couple to another vertex through an edge.

Demand type relationship graph 410 also includes three subgraphs 420-440 that processing identifies when computing a minimum facility requirement. Subgraph 420 encompasses dt1, dt2, and corresponding compatibilities, while subgraph 430 encompasses dt1, dt4, and corresponding compatibilities. Subgraph 440 encompasses dt1, dt2, and dt4, along with corresponding compatibilities. As discussed earlier in FIG. 2, since demand type (dt1) shares between two different demand types (dt2 and dt4), but demand types dt2 and dt2 are incompatible, subgraph 440 represents facility areas to add in to the minimum facility requirement. For example, if dt1 shares 20 facility areas with dt2, then dt1 may not be able to share the same facility areas with dt4 since dt4 cannot share facility areas with dt2.

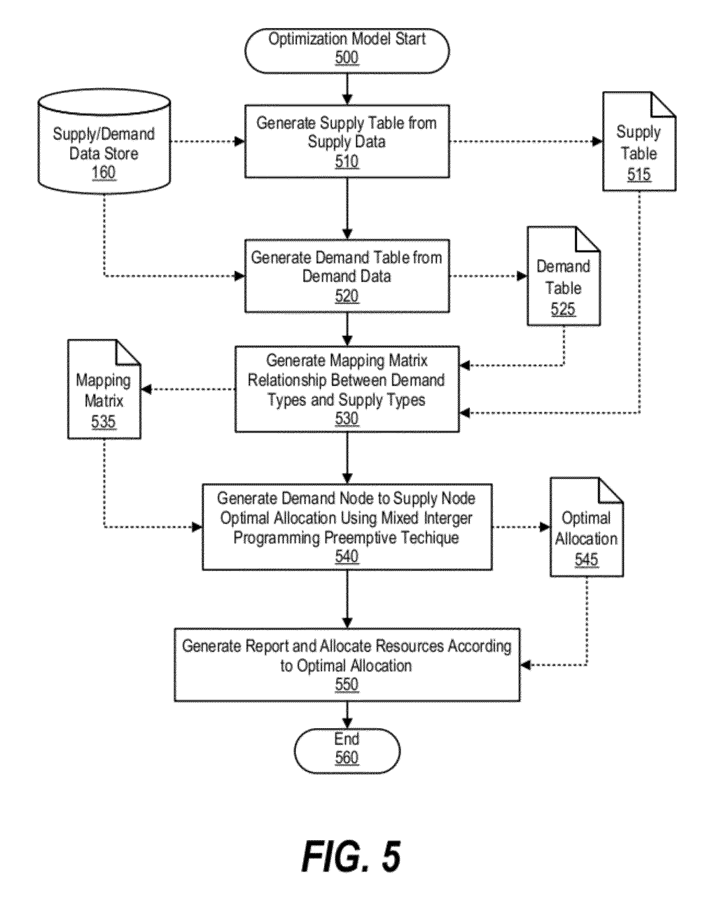

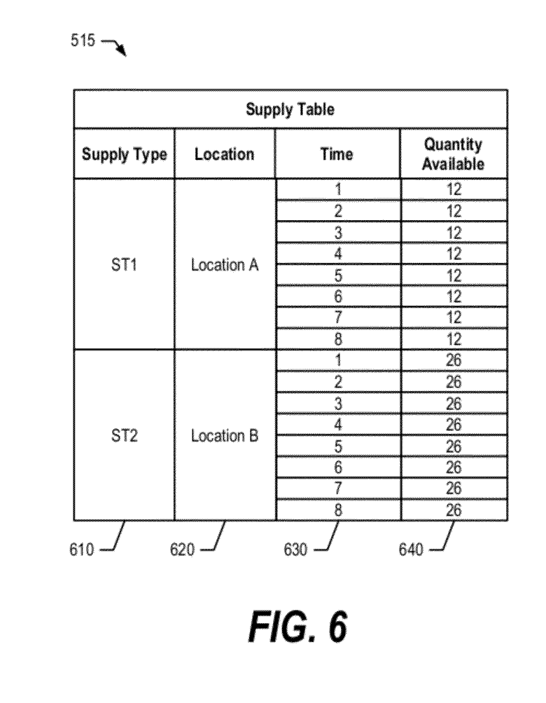

FIG. 5 is a flowchart showing steps taken in an optimization approach to maximizing facility usage. Processing commences at 500, whereupon processing generates supply table 515 from supply data included in supply/demand data store 160. Supply table 515 includes various supply types and supply parameters (see FIG. 6 and corresponding text for further details).

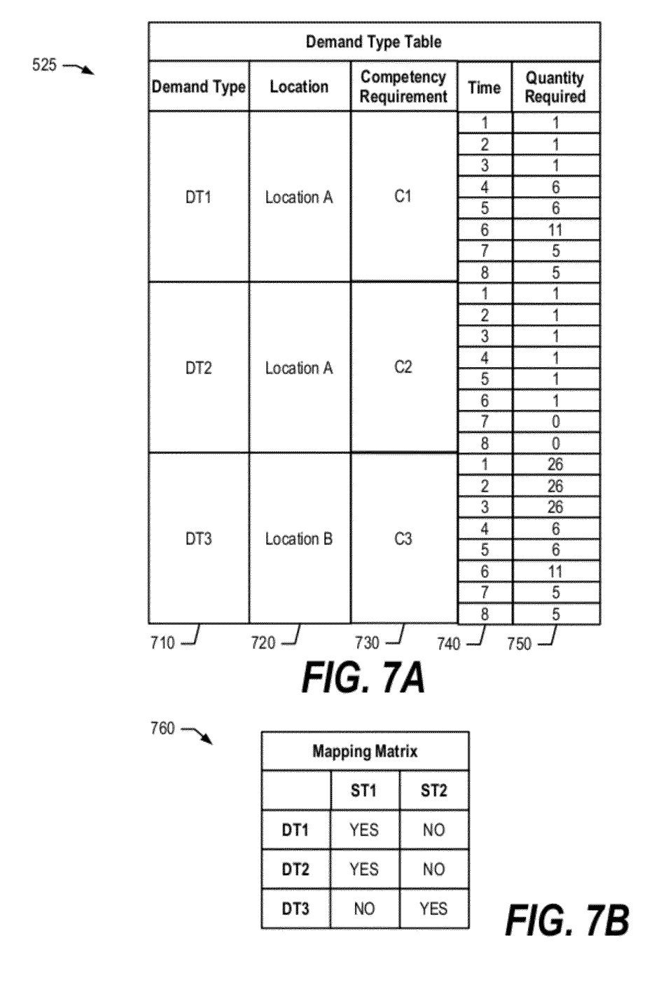

Next, processing generates demand table 525 from demand data included in supply/demand data store 160. The demand type table includes a list of demand types (dt) and corresponding demand requirements (see FIG. 7A and corresponding text for further details). Processing, at step 530, generates mapping matrix 535 using supply table 515 and demand table 525. Mapping matrix 535 maps supply types to demand types based upon a compatibility relationship between their corresponding supply parameters and demand requirements. Referring to FIGS. 6-7B, supply type 1 maps to demand type 1 because supply type 1 is at location A, which is the same location that demand type 1 requires. As those skilled in the art can appreciate, more or less supply parameters and/or demand requirements may be utilized than what is shown in FIGS. 6-7B.

Processing then generates optimum allocation 545 based upon mapping matrix 535 at step 540. In one embodiment, processing uses mixed integer programming (MIP) to generate optimum allocation 545. In this embodiment, processing uses a multi objective linear programming (MOLP) approach as discussed below using the following notation:
T:tε{1 . . .} Time Interval in a 24 hour day;
AWₜ:tε{t,t−1,K ,t−h/2−1} Arrival window at time t;
D_{dt}ⁱ_{,t}: Demand at time t for demand type dtⁱ;
Sₛₜⁱ_{,t}: Supply at time t for supply type stⁱ;
VST_{dt}ⁱ: VST_{dt}ⁱ⊂S Feasible supply type for demand type dtⁱ;
VDTₜⁱ: VDTₛₜⁱ⊂D Feasible demand type for supply type stⁱ;
λₛₜⁱ: Penalty of addign additional facility areas in supply type stⁱ;
M₀: Big M constant (typically large value).

In one embodiment, the MOLP approach realizes demand and supply on a daily basis where each day is divided into “T” time intervals. For the ease of modeling, processing segments demand and supply into 48 half-hourly intervals (e.g., uniform or non-uniform). Processing defines “arrival window” as a function of time to track active facility areas at time t. Mapping from a bi-partite graph can be summarized as two sets, which are valid demand types and valid supply types. As those skilled in the art can appreciate, a bipartite graph is a graph whose vertices are divided into two disjoint sets U and V such that every edge connects a vertex in U to one in V. In one embodiment, processing may associate a “high penalty/cost” of adding new infrastructure when a MOLP problem is infeasible. As such, processing ensures a solution when the facility area supply is not enough to meet the demand by optimally adding supply units. Processing uses this functionality for identifying growth recommendations. In one embodiment, processing uses the following decision variables to solve the MOLP problem:
xₛₜⁱ_{,dt}^{j}_{,t}: Number of facility areas of type stⁱ starting at time t to meet demand type dt^{j};
zₛₜⁱ: Number of facility areas needed to meet demand allocated in stⁱ;
uₛₜⁱ_{,dt}^{j}_{,t}: Number of facility areas of type stⁱ deployed/active in time interval t to meet demand type dtⁱ;
vₛⁱ: Additional facility areas required type stⁱ to meet demand;
wₛₜⁱ_{,dt}^{j}: 1 if stⁱ is active to server dtⁱ, 0 otherwise;
pₛₜⁱ: 1 if supply unit sti is active for any demand type; 0 otherwise.

In one embodiment, the two binary variables above are required to ensure processing meets co-location conditions, such as when co-location is preferred condition but is not a hard constraint. Hence, in this embodiment, processing computes an alternate optima with the co-location condition met at the same optimal objective function value.

In one embodiment, processing decomposes the MOLP problem into three problems in order to reduce memory requirements and time complexity:

$$Minimize \text{:}$$

$$1. Fragmentation = {\sum }_{∀ st} {\sum }_{∀ {VDT}_{st}} {w}_{st , dt} + {\sum }_{∀ st} {λ}_{st} {v}_{st}$$

$$2. Total Facility Areas = {\sum }_{∀ st} {z}_{st} + {\sum }_{∀ st} {λ}_{st} \cdot {v}_{st}$$

$$3. Total Demand Requirement = {\sum }_{∀ st} {\sum }_{∀ {VDT}_{st}} {\sum }_{∀ t} {x}_{st , dt , t} + {\sum }_{∀ st} {λ}_{st} \cdot {v}_{st}$$

$${u}_{st , dt , t} = {\sum }_{t ∈ {AW}_{t}} {x}_{st , dt , t} ∀ st ∈ S ∀ t ∈ T$$

$$∀ dt ∈ {VDT}_{st}$$

$${D}_{dt , t} \leq {\sum }_{st ∈ {VST}_{dt}} {u}_{st , dt , t} ∀ t ∈ T$$

$$∀ dt ∈ D$$

$${\sum }_{dt ∈ {VDT}_{st}} {u}_{st , dt , t} \leq {S}_{st , t} \cdot {p}_{st} + {v}_{st} ∀ t ∈ T , ∀ st$$

$${z}_{st} \geq {\sum }_{∀ {VDT}_{st}} {u}_{st , dt , t} ∀ t ∈ T , ∀ st$$

$${\sum }_{∀ t} {x}_{st , dt , t} \leq {M}_{0} \cdot {w}_{st , dt} ∀ st ∈ S , ∀ dt ∈ D$$

$${\sum }_{st ∈ {VDT}_{st}} {w}_{st , dt} \geq 1 ∀ dt ∈ D$$

$${w}_{st , dt} \leq {p}_{st} ∀ st , dt ∈ {VDT}_{st}$$

The optimal solution from the MOLP model above provides the following optimal allocation:

$$OA = \frac{{\sum }_{∀ st} {\sum }_{∀ {VDT}_{st}} {\sum }_{∀ t} {x}_{st , dt , t}}{{\sum }_{∀ st} {z}_{st}}$$

In turn, at step 550, processing allocates facility area resources according to the optimal allocation derived in step 540, and processing ends at 560.

FIG. 6 is a diagram showing a supply table that includes supply types and corresponding supply type attributes. Table 515 includes two supply types in column 610 and corresponding supply type attributes in columns 620-640. Column 620 includes a list of geographical location attributes that correspond to the two different supply types (locations “A” and “B”), and column 630 includes a list of shift attributes for the different supply types (times 1-8). Column 640 includes a list of quantity available attributes (facility areas available) for the corresponding shift times in column 630.

FIG. 7A is a diagram showing a demand type table. Table 700 includes three different demand types. Column 710 includes a list of demand type identifiers dt1-dt3, while columns 720-750 include a set of demand requirements for each of the demand types.

Column 720 includes a list of geographical location requirements for each of the different demand types. Column 730 includes a list of competency requirements for each of the demand types. In one embodiment, the competency requirements correspond to a particular company or corporation. Columns 740 and 750 include a list of shift times for each demand type and each shift time's respective quantity requirements.

FIG. 7B is a diagram showing a mapping matrix that maps supply types from FIG. 6 to demand types in FIG. 7A. As can be seen, mapping matrix 760 maps supply type 1 to demand type 1 since supply type 1's location parameter is location “A,” which is the same location that demand type 1 requires. As those skilled in the art can appreciate, more or less supply parameters and/or demand requirements may be utilized than what is shown in FIGS. 6-7B.

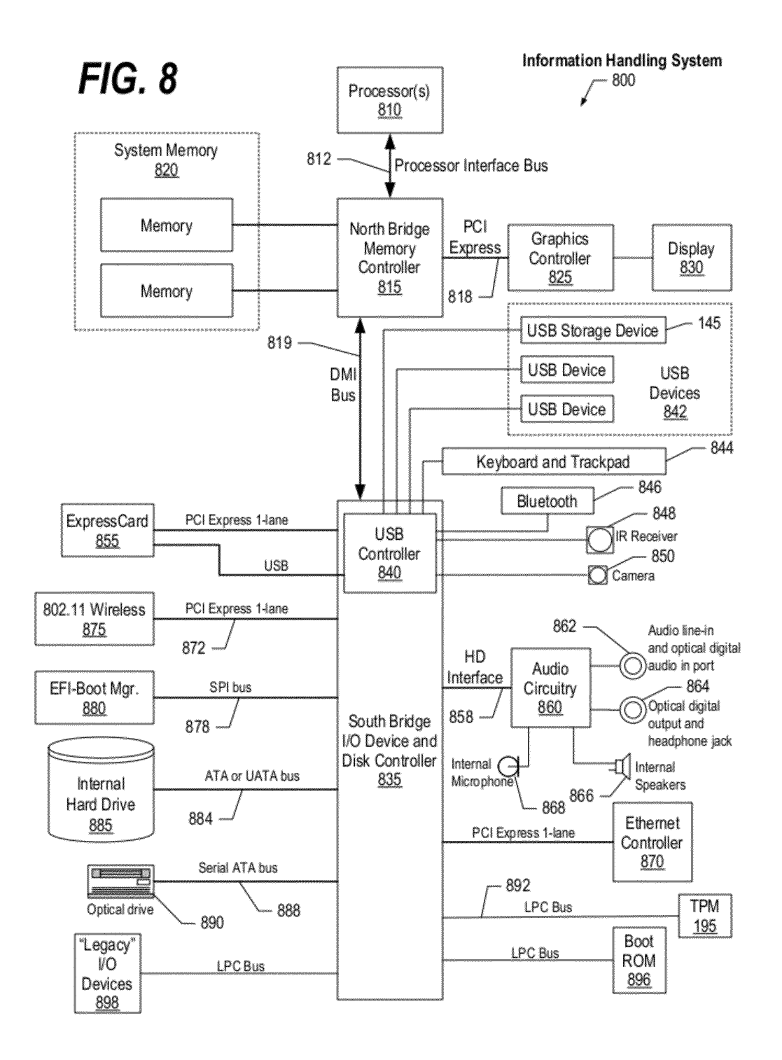

FIG. 8 illustrates information handling system 800, which is a simplified example of a computer system capable of performing the computing operations described herein. Information handling system 800 includes one or more processors 810 coupled to processor interface bus 812. Processor interface bus 812 connects processors 810 to Northbridge 815, which is also known as the Memory Controller Hub (MCH). Northbridge 815 connects to system memory 820 and provides a means for processor(s) 810 to access the system memory. Graphics controller 825 also connects to Northbridge 815. In one embodiment, PCI Express bus 818 connects Northbridge 815 to graphics controller 825. Graphics controller 825 connects to display device 830, such as a computer monitor.

Northbridge 815 and Southbridge 835 connect to each other using bus 819. In one embodiment, the bus is a Direct Media Interface (DMI) bus that transfers data at high speeds in each direction between Northbridge 815 and Southbridge 835. In another embodiment, a Peripheral Component Interconnect (PCI) bus connects the Northbridge and the Southbridge. Southbridge 835, also known as the I/O Controller Hub (ICH) is a chip that generally implements capabilities that operate at slower speeds than the capabilities provided by the Northbridge. Southbridge 835 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 896 and “legacy” I/O devices (using a “super I/O” chip). The “legacy” I/O devices (898) can include, for example, serial and parallel ports, keyboard, mouse, and/or a floppy disk controller. The LPC bus also connects Southbridge 835 to Trusted Platform Module (TPM) 895. Other components often included in Southbridge 835 include a Direct Memory Access (DMA) controller, a Programmable Interrupt Controller (PIC), and a storage device controller, which connects Southbridge 835 to nonvolatile storage device 885, such as a hard disk drive, using bus 884.

ExpressCard 855 is a slot that connects hot-pluggable devices to the information handling system. ExpressCard 855 supports both PCI Express and USB connectivity as it connects to Southbridge 835 using both the Universal Serial Bus (USB) the PCI Express bus. Southbridge 835 includes USB Controller 840 that provides USB connectivity to devices that connect to the USB. These devices include webcam (camera) 850, infrared (IR) receiver 848, keyboard and trackpad 844, and Bluetooth device 846, which provides for wireless personal area networks (PANs). USB Controller 840 also provides USB connectivity to other miscellaneous USB connected devices 842, such as a mouse, removable nonvolatile storage device 845, modems, network cards, ISDN connectors, fax, printers, USB hubs, and many other types of USB connected devices. While removable nonvolatile storage device 845 is shown as a USB-connected device, removable nonvolatile storage device 845 could be connected using a different interface, such as a Firewire interface, etcetera.

Wireless Local Area Network (LAN) device 875 connects to Southbridge 835 via the PCI or PCI Express bus 872. LAN device 875 typically implements one of the IEEE 802.11 standards of over-the-air modulation techniques that all use the same protocol to wirelessly communicate between information handling system 800 and another computer system or device. Optical storage device 890 connects to Southbridge 835 using Serial ATA (SATA) bus 888. Serial ATA adapters and devices communicate over a high-speed serial link. The Serial ATA bus also connects Southbridge 835 to other forms of storage devices, such as hard disk drives. Audio circuitry 860, such as a sound card, connects to Southbridge 835 via bus 858. Audio circuitry 860 also provides functionality such as audio line-in and optical digital audio in port 862, optical digital output and headphone jack 864, internal speakers 866, and internal microphone 868. Ethernet controller 870 connects to Southbridge 835 using a bus, such as the PCI or PCI Express bus. Ethernet controller 870 connects information handling system 800 to a computer network, such as a Local Area Network (LAN), the Internet, and other public and private computer networks.

While FIG. 8 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

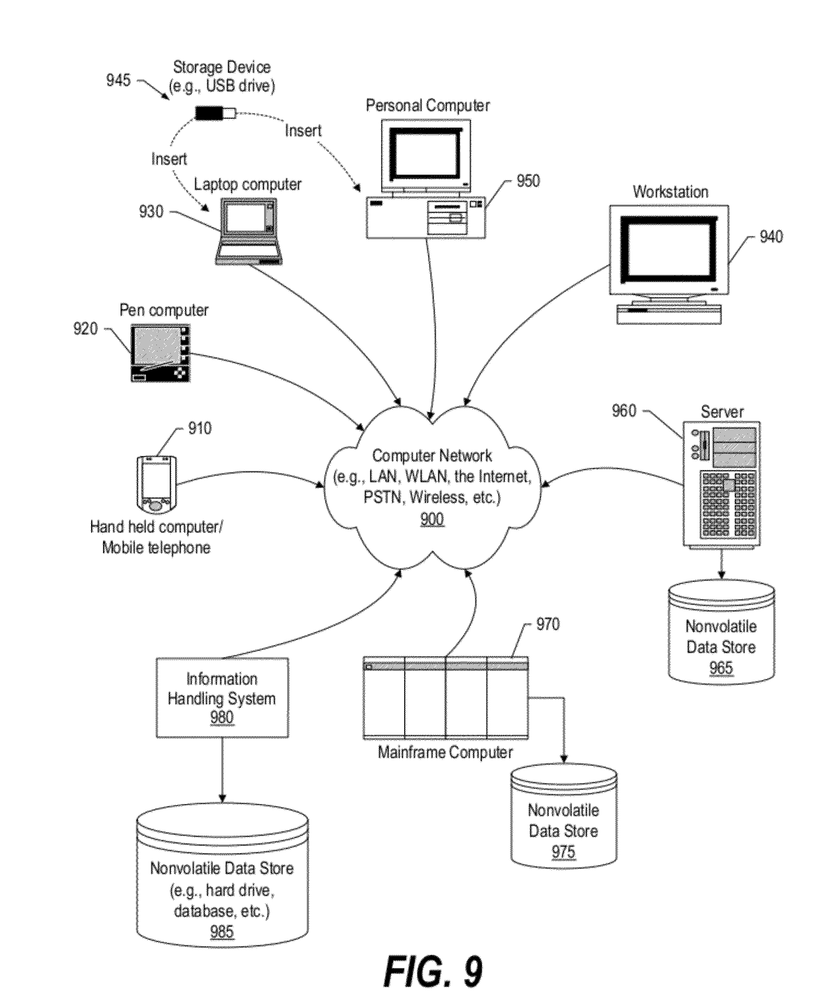

The Trusted Platform Module (TPM 895) shown in FIG. 8 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 9.

FIG. 9 provides an extension example of the information handling system environment shown in FIG. 8 to illustrate that the methods described herein can be performed on a wide variety of information handling systems that operate in a networked environment. Types of information handling systems range from small handheld devices, such as handheld computer/mobile telephone 910 to large mainframe systems, such as mainframe computer 970. Examples of handheld computer 910 include personal digital assistants (PDAs), personal entertainment devices, such as MP3 players, portable televisions, and compact disc players. Other examples of information handling systems include pen, or tablet, computer 920, laptop, or notebook, computer 930, workstation 940, personal computer system 950, and server 960. Other types of information handling systems that are not individually shown in FIG. 9 are represented by information handling system 980. As shown, the various information handling systems can be networked together using computer network 900. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 9 depicts separate nonvolatile data stores (server 960 utilizes nonvolatile data store 965, mainframe computer 970 utilizes nonvolatile data store 975, and information handling system 980 utilizes nonvolatile data store 985). The nonvolatile data store can be a component that is external to the various information handling systems or can be internal to one of the information handling systems. In addition, removable nonvolatile storage device 945 can be shared among two or more information handling systems using various techniques, such as connecting the removable nonvolatile storage device 945 to a USB port or other connector of the information handling systems.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

What is claimed is:

1. A machine-implemented method comprising:
identifying, by a processor, a first demand type and a second demand type, wherein the first demand type includes a first set of demand requirements and the second demand type includes a second set of demand requirements;
retrieving, by the processor, a demand compatibility rule, the demand compatibility rule identifying a compatibility between the first set of demand requirements and the second set of demand requirements;
computing, by the processor, a demand type overlap value between the first demand type and the second demand type based upon the demand compatibility rule;
computing, by the processor, a minimum facility requirement based upon the demand type overlap value; and
generating, by the processor, a facility report that includes the minimum facility requirement.

2. The method of claim 1 further comprising:
computing a total demand quantity based upon the first set of demand requirements and the second set of demand requirements;
computing a facility utilization value based upon the total demand quantity and the facility requirement; and
wherein the facility report includes the facility utilization value.

3. The method of claim 1 wherein one of the first set of demand requirements is selected from the group consisting of a geographical location requirement, a competency requirement, and a technology requirement.

4. The method of claim 1 wherein the identified compatibility is between a subset of the first set of demand requirements and a subset of the second set of demand requirements.

5. The method of claim 1 wherein the demand compatibility rule specifies an incompatibility between a subset of the first set of demand requirements and a subset of the second set of demand requirements.

6. The method of claim 1 further comprising:
generating a demand compatibility relationship graph, wherein the demand compatibility relationship graph includes:
a first vertex corresponding to the first demand requirement and a second vertex corresponding to the second demand requirement; and
an edge that couples to the first vertex and the second vertex, wherein the edge corresponds to the demand type overlap value.

7. A machine-implemented method comprising:
identifying, by a processor, a plurality of supply types, wherein each of the plurality of supply types correspond to one or more supply type attributes;
identifying, by a processor, a plurality of demand types, wherein each of the plurality of demand types correspond to one or more demand requirements;
identifying one or more compatibilities between the one or more supply computing, by the processor, a mapping matrix that maps the plurality of supply types to the plurality of demand types according to the identified one or more compatibilities;
computing, by the processor, an optimal facility allocation based upon the mapping matrix; and
generating, by the processor, a facility report that includes the optimal facility allocation.

8. The method of claim 7 wherein the processor utilizes mixed-integer programming to compute the optimal facility allocation; and

9. The method of claim 7 wherein:
one of the demand requirements is selected from the group consisting of a geographical location requirement, a competency requirement, a shift requirement, and a quantity requirement; and
one of the supply type attributes is selected from the group consisting of a geographical location attribute, a shift attribute, and a quantity available attribute.

10. A computer program product stored in a computer readable storage medium, comprising functional descriptive material that, when executed by an information handling system, causes the information handling system to perform actions that include:
identifying a first demand type and a second demand type, wherein the first demand type includes a first set of demand requirements and the retrieving a demand compatibility rule, the demand compatibility rule identifying a compatibility between the first set of demand requirements and the second set of demand requirements;
computing a demand type overlap value between the first demand type and the second demand type based upon the demand compatibility rule;
computing a minimum facility requirement based upon the demand type overlap value; and
generating a facility report that includes the minimum facility requirement.

11. The computer program product of claim 10 wherein the information handling system performs actions that include:
computing a total demand quantity based upon the first set of demand requirements and the second set of demand requirements;
computing a facility utilization value based upon the total demand quantity and the facility requirement; and
wherein the facility report includes the facility utilization value.

12. The computer program product of claim 10 wherein one of the first set of demand requirements is selected from the group consisting of a geographical location requirement, a competency requirement, and a technology requirement.

13. The computer program product of claim 10 wherein the identified compatibility is between a subset of the first set of demand requirements and a subset of the second set of demand requirements.

14. The computer program product of claim 10 wherein the demand compatibility rule specifies an incompatibility between a subset of the first set of demand requirements and a subset of the second set of demand requirements.

15. The computer program product of claim 10 wherein the information handling system performs actions that include:
generating a demand compatibility relationship graph, wherein the demand compatibility relationship graph includes:
a first vertex corresponding to the first demand requirement and a second vertex corresponding to the second demand requirement; and
an edge that couples to the first vertex and the second vertex, wherein the edge corresponds to the demand type overlap value.

16. An information handling system comprising:
one or more processors;
a memory accessible by at least one of the processors;
a set of instructions stored in the memory and executed by at least one of the processors in order to perform actions of:
identifying a first demand type and a second demand type, wherein the first demand type includes a first set of demand requirements and the second demand type includes a second set of demand requirements;
retrieving a demand compatibility rule, the demand compatibility rule identifying a compatibility between the first set of demand requirements and the second set of demand requirements; computing a demand type overlap value between the first demand type and the second demand type based upon the demand compatibility rule;
computing a minimum facility requirement based upon the demand type overlap value; and
generating a facility report that includes the minimum facility requirement.

17. The information handling system of claim 16 wherein the set of instructions, when executed by at least one of the processors, further performs actions of:
computing a total demand quantity based upon the first set of demand requirements and the second set of demand requirements;
computing a facility utilization value based upon the total demand quantity and the facility requirement; and
wherein the facility report includes the facility utilization value.

18. The information handling system of claim 16 wherein one of the first set of demand requirements is selected from the group consisting of a geographical location requirement, a competency requirement, and a technology requirement.

19. The information handling system of claim 16 wherein the identified compatibility is between a subset of the first set of demand requirements and a subset of the second set of demand requirements.

20. The information handling system of claim 16 wherein the demand compatibility rule specifies an incompatibility between a subset of the first set of demand requirements and a subset of the second set of demand
